(19) United States
(12) Patent Application Publication
(10) Pub. No.: US 2014/0025646 A1
(43) Pub. Date: Jan. 23, 2014

(54) DATA MANAGEMENT IN A DATA VIRTUALIZATION ENVIRONMENT

(71) Applicants: Carolina Canales Valenzuela, Madrid (ES); Juan Antonio Sanchez Herrero, Madrid (ES)

(72) Inventors: Carolina Canales Valenzuela, Madrid (ES); Juan Antonio Sanchez Herrero, Madrid (ES)

(73) Assignee: TELEFONAKTIEBOLAGET L M ERICSSON (PUBL), Stockholm (SE)

(21) Appl. No.: 14/008,402

(22) PCT Filed: Mar. 28, 2011
(86) PCT No.: PCT/EP2011/054736

§ 371 Date: Sep. 27, 2013

(51) Int. Cl. G06F 17/30

(52) U.S. Cl. CPC G06F 17/30371
USPC 707/691

(57) ABSTRACT

The invention relates to a system handling a plurality of data sets stored in different repositories (310, 320), the system comprising a data managing unit (200) configured to provide processing rules for processing the data sets stored in the different repositories, the processing rules including access rules providing information which of the data repositories should be accessed in the case of a data access request for one of the data sets, the processing rules further including consistency enforcement rules providing correction actions when an inconsistency for said one data set stored in different data repositories is detected. Furthermore, a virtualizing unit is detected which is configured to control data access requests for the data sets and configured to enforce the processing rules provided by the data managing unit (200), wherein, when the data virtualizing unit (100) detects the data access request for said one data set, the data virtualizing unit handles the data access request for said one data set, accesses at least two repositories (310, 320) where said one data set is stored based on the access rules, and corrects a detected inconsistency for said one data set based on the consistency enforcement rules.

### TECHNICAL FIELD

The invention relates to a system for handling a plurality of data sets stored in different repositories, to a virtualization unit handling an access to the data sets, a data managing unit configured to manage the plurality of data sets and a method for handling the plurality of data sets stored in different repositories.

### RELATED ART

Telecom operators are facing growing challenges in order to access disparate sources of user-related data managed by different applications or network elements. One of the solutions is data virtualization that allows integrating in real time heterogeneous data and content stored in disparate repositories.

One general problem on data management is covered in the IT industry by Master Data Management (MDM) solutions that include processes, policies, services and technologies used to create, maintain and manage data. In addition MDM is also used to consolidate, clean and augment the corporate master data.

The general data quality strategies in these solutions are focused on data audit and input data verification. In practice it implies that the data virtualization middleware controls all the information transactions with data repositories and assure data quality using different Change Data Capture (CDC) technologies.

Change Data Capture is a set of software design patterns used to determine (and track) data that has changed in a database, so that action can be taken using that changed data immediately. CDC is also an approach to data integration that is based on the identification, capture and delivery of the changes made to different data sources. Although it occurs most often in data warehouse environments, it can also be utilized in any database or data repository system. Not commonly, multiple CDC solutions can exist in a single system, but we can summarize the different types in the following way:

1. Trigger or application-based: Changes are tracked in separate tables directly by the process modifying the data record, or indirectly via triggers in a set of additional tables. This obviously adds significant overhead to the source system, but triggers are always there to accomplish change tracking.
2. Audit-based: Application tables are augmented with additional columns that, upon the application of data manipulation (DML) operations against the records in the operational table, are populated with time stamps, change tracking version numbers, status indicators (e.g. Boolean for changed data) or a combination of them. The drawback here is the overhead due to index and table scans to process the next set of data.
3. Network sniffers: These tools watch the network traffic directly, filter it for some specific patterns and save the output. This method is widely used for monitoring user behavior through saving of clicks on web pages (Web clickstream), so one does not have to bother with a collection of different log files. It also gives a deeper insight into the structure and content of the data sent by the different dynamic web pages. It is not directly relevant for changes tracked in database systems.
4. Log-based: Most database management systems manage a transactional log that records changes to the database contents and metadata. By scanning and interpreting the contents of the database transaction log one can capture the changes made to the database in a non-intrusive manner. This is the most efficient way to monitor for changes without impacting the source system. Several database vendors offer CDC APIs to capture changes within their databases.

Apart from this state of the art technology existing in the IT industry, the telecom industry has defined the 3GPP GUP standard (see references

TS 22.240, http://www.3gpp.org/ftp/specs/html-info/22240.htm,
TS 23.240, http://www.3gpp.org/ftp/Specs/html-info/23240.htm,
TS 29.240, http://www.3gpp.org/ftp/Specs/html-info/29240.htm and
TS 23.941, http://www.3gpp.org/ftp/specs/html-info/23941.htm)
3GPP GUP (Generic User Profile) defines a framework (architecture and set of protocols) providing a homogeneous access to the user profile information stored in the operator's network.

GUP allows operators to integrate any required data repositories and present the available data in customized data views towards applications requesting the data, and provides a single point of access towards application with a single access protocol and a single user identifier. Data is aggregated from different data sources and transformed into suitable data views for the applications with the necessary access control, security and privacy enforcement mechanisms.

In FIG. 1 the GUP network architecture is shown. The GUP architecture contains the following network elements: applications 10 corresponding to consumers of the user profile information. Furthermore, a GUP server 20 is provided and GUP data repositories 31. The GUP data repositories 31 are accessed using repository access functions (RAF 30). According to the GUP standard applications are the consumers of information belonging to the user profile which can be both operator's own applications and third party application. The GUP server 20 is a functional entity providing a single point access to the suite of data that conform the generic user profile of a particular subscriber, in order to ensure a consistent access, since such data is usually spread in different databases inside the network accessible by means of heterogeneous technologies.

The Generic User Profile includes information used for configuration and personalization of end-user services, and that identifies a specific user inside the network. Such information includes for instance preferences, rules, and settings, which affects the way the user experiences terminals, devices and services. According to the Stage 3 of the standard (architectural description), the GUP Server should theoretically include the following main functionalities:
Location of Profile Components.
Authentication of profile requests.
Authorization of profile requests.
Synchronization of Profile Components.
Data model composition and abstraction
Abstraction of the topology of the underlying network infrastructure
Isolation (protection) of the underlying network infrastructure

The GUP data repositories 31 are network elements hosting the user profile information. The repository access function 30 realizes the harmonized access interface towards the data repositories. It hides the implementation details of the data repositories from the GUP infrastructure. The RAF performs protocol and data transformation where needed. The protocol between the RAF and the GUP data repository 31 is out of the standardization scope. It is recommended that the protocol used should support GUP requirements.

The data quality problem addressed by typical IT MDM solutions is not completely covered on data virtualization environments, even more if we focus on the telecom environment. The general data quality strategies are focused on data audit and input data verification. In practice it implies that the data virtualization middleware controls all the information transactions with data repositories and assures data quality using different technologies, or has effective means to actually detect changes in the repositories.

In some scenarios (e.g. the data bases serving telecommunication networks) the data repositories can be accessed and manipulated by means which avoid a close control by data virtualization software, implying difficulties to assure the data quality in this scenarios. In other words, even if a Data Virtualization system was created in order to provide an homogenous data access towards the repositories, and this system was also in charge of ensuring the consistency and persistency of the data universe, the typical IT solutions would fail in the second task, due to their inability to track the data changes in the telecom repositories (many of these repositories do not support incremental change detection mechanisms, and can be concurrently accessed by multiple systems, apart from the Data Virtualization software).

Examples of data on a telecom network accessible outside the control of virtualization system are the Supplementary Service information updated by the user in his terminal in HLR/HSS, or the Presence/Group information updated by the user via XCAP in PGM (Presence Group Data Management), XCAP describing a protocol used to access PGM.

Additionally, even if the 3GPP GUP standard states that the GUP Server should perform synchronization of Profile Components, in fact it does not define any mechanisms or special architecture to actually perform such tasks (just the mechanisms for repository access and data transformation/composition), being this issue completely unresolved in telecommunication networks.

### SUMMARY

Accordingly, a need exists to assure the data consistency of data sets stored in different repositories even when the data access cannot always be mediated or automatically detected by a data virtualization software.

This need is met by the features of the independent claims. In the dependent claims preferred embodiments of the invention are described.

According to a first aspect a system handling a plurality of data sets stored in different repositories is provided, the system comprising a data managing unit configured to provide processing rules for processing the data sets stored in the different repositories. The processing rules include access rules providing information which of the data repositories should be accessed in the case of a data access request for one of the data sets and the processing rules further include consistency enforcement rules providing correction actions when an inconsistency for said one data set stored in different data repositories is detected. The system furthermore comprises a virtualizing unit configured to control data access requests for the data sets and configured to enforce the processing rules provided by the data management unit, wherein, when the data virtualization unit detects the data access request for said one data set, the data virtualizing unit handles the data access request for said one data set, accesses at least two repositories where said one data set is stored based on the access rules and corrects a detected inconsistency for said one data set based on the consistency enforcement rules. The data managing unit provides a set of rules to handle the data sets in which potential inconsistencies of the data sets originated in different data repositories are detected and corrected whenever the data set is accessed and retrieved, be it for reading or writing. The data access triggers the desired verification and correction procedures carried out by the virtualization unit, the rules being provided by the data managing unit.

According to one embodiment the processing rules provided in the data managing unit may further include inconsistency detection rules providing information what to do with data sets retrieved from the at least two repositories for data access request for said one data set. In this embodiment the virtualizing unit can be configured to compare the data sets contained in the access repositories relating to the detected data access request and can be configured to detect the inconsistency in the compared data sets based on the inconsistency detection rules provided by the data managing unit. The inconsistency detection rules may contain instruction to compare all stored instances of a data set for an access request, to compare only some of the data sets or not to compare the data sets at all.

The data managing unit may further contain final result rules providing information about a final result to be returned for said one data set in response to the data access request for said one data set. The virtualizing unit is then configured to generate the final result for said one data set in response to the data set access request for said one data set based on the final result rules. By way of example the final result rules may determine if an inconsistency has been detected, if all possible instances of the data sets can be returned, if only one data set is returned or if a master data set is returned.

Furthermore, the data managing unit may contain, for each of the data sets, information which of the data sets stored in the different repositories is the master dataset considered as the dataset containing the correct information. If an inconsistency for a data set stored in two different repositories is detected, rules may be necessary describing which of the data sets contains the correct information. This data set is considered as the master dataset. In case of an inconsistency the other data sets can be rendered consistent with the master data set.

The invention furthermore relates to the virtualization unit handling the access to the data sets stored in the different repositories, the virtualization unit comprising a first interface configured to receive processing rules for processing the data sets stored in the different repositories from a data managing unit. The processing rules include the access rules providing information which of the data repositories should be accessed in case of the data access request for one of the data sets, the processing rules further including the consistency enforcement rules providing the correction actions when an inconsistency for said one data set stored in the different data repositories is detected. The virtualizing unit furthermore contains a processing unit configured to control the data access requests for the data sets and configured to enforce the processing rules provided by the data managing unit. When the processing unit detects a data access request for one data set, it handles the data access request for said one data set, accesses at least two repositories based on the access rules and corrects the detected inconsistency based on the consistency enforcement rules. The virtualizing unit is a functional entity that handles the data access according to the data access rules provided by the data managing unit. These rules guide the behavior of the virtualizing unit regarding the data access and may for instance indicate applicably data access and transformation rules and the actions to be taken to guarantee the data quality.

The received processing rules received by the first interface of the virtualizing unit can, in another embodiment, furthermore include the inconsistency detecting rules providing information what to do with data sets retrieved from the at least two data repositories for the data access request for said one data set. The processing unit is then configured to compare the data sets contained in the accessed repositories and configured to detect the inconsistency in the compared data sets based on the inconsistency detection rules.

Via the first interface furthermore the final result rules may be received providing information about a final result to be returned for said one data set in response to the data access request for said one data set as mentioned above.

The invention furthermore relates to the data managing unit configured to manage a plurality of data sets stored in different repositories, the data managing unit comprising a storage unit storing the processing rules including the access rules and the consistency enforcement rules discussed above. The data managing unit furthermore contains an interface providing the processing rules to the virtualizing unit which enforces the received processing rules for the data managing unit.

The invention furthermore relates to a method for handling a plurality of data sets stored in different repositories. The method comprises the step of receiving a data access request for one of the data sets. In an additional step at least two repositories are accessed where the data set for which the data access request is received is stored based on access rules providing information which of the data repositories should be accessed in the case of a data access request for one of the data sets. The method further contains the step of detecting inconsistencies for said one data set stored in the at least two repositories based on inconsistency detection rules providing information what to do with data sets retrieved from the at least two repositories for a data access request for said one data set. The invention furthermore contains the step of correcting an inconsistency for said one data set based on inconsistency enforcement rules providing correction actions when an inconsistency for said one data set stored in different repositories is detected.

These method steps allow to provide a data quality assurance mechanism in which inconsistencies are detected when an access request for a data set for said data set is received.

### BRIEF DESCRIPTION OF THE DRAWINGS

The invention will be described in further detail with reference to the accompanying drawings, in which

FIG. 1 shows a GUP architecture known in the art,

FIG. 2 shows a system handling a plurality of data sets stored in different repositories of the invention,

FIG. 3 shows an embodiment incorporating the system of FIG. 2 using a GUP architecture, and

FIG. 4 shows a state diagram including the decision flow for a query for a data set, an inconsistency check and the return of the data query result for a system of FIG. 2 or 3.

### DETAILED DESCRIPTION

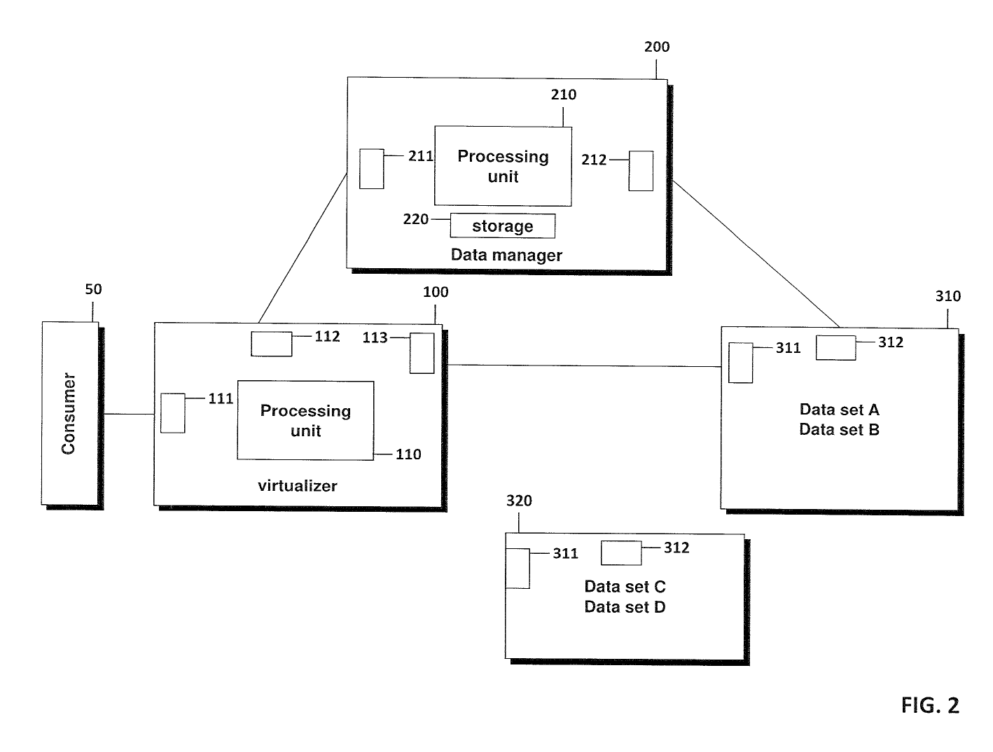

In FIG. 2 a system is shown with which the data quality can be assured for data sets stored in different repositories 310, 320 even when the data sets can be directly accessed by means outside the control of a data virtualization software which may be carried out by a data virtualizing unit 100. The data virtualizing unit is normally not able to automatically detect all the data modifications in the repositories 310, 320. As will be described in further detail below, it performs the detection upon the actual data access process, counting on specific logic, access and automatic correction procedures using rules provided by a data managing unit 200 which define the behavior of the system in such a situation.

A data consumer 50 accesses the data sets in the data repositories 310, 320 via an interface a the virtualizing unit 100 containing an interface 111 for the access by the consumer, an interface for a data exchange between the data virtualizing unit and the data managing unit (the interface 112) and an interface 113 for the exchange of information with a data repository 310.

The data repositories 310, 320 contain an interface 311 for the access by the data virtualizing unit and an interface 312 for the access by the data managing unit. The data repositories store the data sets of the system. The data sets are accessed by the consumer 50 by means of the data virtualizing unit 100 using interface d. The data sets in the data repository can be modified directly by the data virtualizer or by other interconnected systems not part of the data virtualization solution and not shown in the embodiment of FIG. 2.

The data virtualizing unit 100 is the functional entity handling the data access according to data access rules provided by the data managing unit 200. Such rules will guide the behavior of the data virtualizing unit regarding data access, and will, for instance, indicate applicable data access transformation rules and actions to be taken to guarantee the data quality. By way of example it determines which of the data instances should be accessible for each data consumer, it determines the number of data instances that should be accessed, the behavior in case of data inconsistency and the data instance to be actually returned. The data virtualizer guarantees the data quality using the rules specified in further detail below.

The data managing unit 200 is a functional entity that provides data management rules to the data virtualizing unit via interface 211 and can operate directly the data repositories via interface 212 when there is a need to guarantee the proper data quality. Examples of this access is the access to data models of data repositories that are the base for the data management rules or mechanisms to use notification of data changes in data repositories, e.g. a repository failure. When these changes are identified, the data managing unit can adapt the data management rules to cope with the identified situation. To this end a processing unit 210 is provided that is used to control the functioning of the data managing unit. The data managing unit comprises an interface 211 for the connection to the data virtualizing unit and an interface 212 for the connection to the data repositories. The data managing unit furthermore contains a storage unit 220 storing the processing rules for processing the data sets.

The processing rules, specific from this invention, guiding the behavior of the data virtualizing unit can be categorized in four categories. The data managing unit provides consumer access rules. These rules determine, depending on the requesting data consumer, which of the instances representing the same data set should be accessed. As an example the following possibilities could apply: access all data instances of the data set, access only a master instance or access a subset of data instances with a specification which of the instances should be accessed. The data managing unit furthermore provides inconsistency detection rules. These rules determine what should be done with the multiple data set instances once one of the data sets or more of the data sets have been accessed using the consumer access rules. By way of example the rules could contain regulations, such as compare the value of each of the instances. Another possibility could be to instruct not to compare the different data sets.

The data managing unit furthermore contains consistency enforcement rules which determine whether or not consistency should be ensured across the different data sets. By way of example the rule could contain the request to overwrite all instances to match the master instance or not to overwrite the actual value of any instance and to keep the inconsistency if existing. Another rule may be to overwrite only a subset of the instances.

The data managing unit furthermore provides the final result rules which determine the final result to be returned to the data consumer. By way of example if an inconsistency has not been enforced and multiple instances/data sets coexist, the rule could be to return all the possible data sets, to return only a subset of the data sets or to return only the master.

In general, the rules might be applied in the same order in which the rules have been described above. First, the consumer access rules, then the inconsistency detection rules are applied followed by the consistency enforcement and the final result rules. The rules will be stored in the data manager in the storage unit 220, the data managing unit typically working as policy repository function PRF. However, the rules will be evaluated and enforced by the data virtualizing unit 100 which plays the role of the policy enforcement and policy decision point.

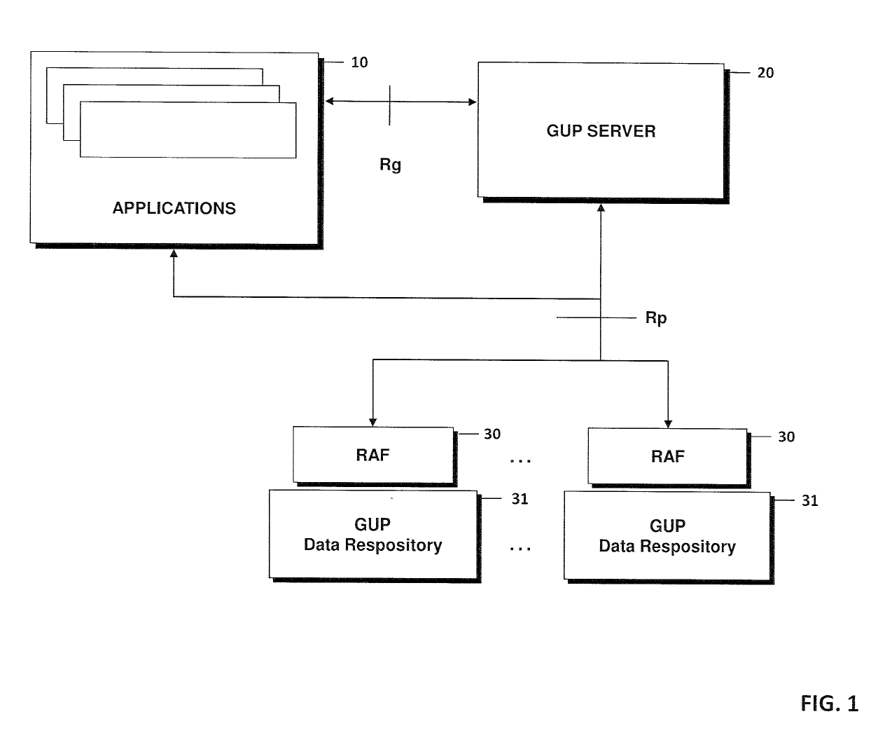

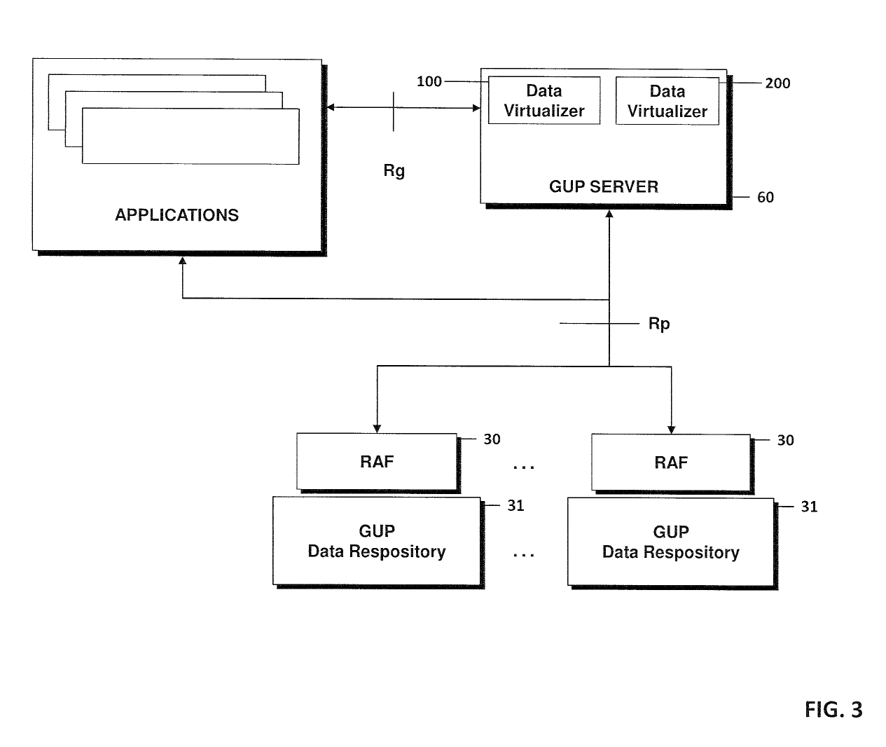

In connection with FIG. 3 an embodiment of the system of FIG. 2 is disclosed using the GUP structure. The data virtualizing unit 100 and the data managing unit 200 may be incorporated into a GUP server 60. If the system of FIG. 2 is incorporated into the GUP structure, the data consumer corresponds to consumers of the user profile information. The architecture shown in FIG. 3 furthermore contains the repository access function RAF 30, which corresponds to the RAF shown in FIG. 1. The data repositories correspond to the GUP data repositories 31. The data managing unit 200 may also be implemented as part of the GUP server 60 providing the data management rules used by the data virtualizing unit 100 and operating the GUP data repositories 31 when there is a need to guarantee the proper data quality. The data quality is guaranteed using the processing rules discussed above. The different entities shown in FIGS. 2 and 3 may be incorporated by hardware, software or a combination of hardware and software.

Referring to FIGS. 2 and 3 in general the data managing unit may contain for each of the data sets information which of the data sets stored in different repositories is the master data set considered as the data set containing the correct information. If an inconsistency between two data sets is detected, the virtualizing unit needs to determine somehow which is the correct data set. This is determined using the information about the master data set.

Furthermore, in general terms, when a data access request is received by the data virtualizing unit, the data virtualizing unit is configured to determine in which data repositories said one data set for which the access request is received is stored.

Furthermore, if the virtualizing unit detects an inconsistency in said one data set for which the data access request is received, it determines which is the master data set and controls the data sets of the different repositories for which the data access request is received in such a way that the data sets of the different repositories, for which the data access request is received, match the master data set of said one data set. If the processing unit in the virtualizing unit detects an inconsistency in the data set for which the data access request is received, it determines which is the master data set and controls the data sets of the different repositories (310, 320) for which the data access request is received in such a way that the data sets of the different repositories for which the data access request is received match the master data set of said one data set.

Sometimes it is possible that predefined functional relationships exist between different data sets. By way of example a first data set may include an information about the geographical location in which a mobile user is located. By way of example it can contain information about a city or any other details where a user is located. Additionally, another data set may be provided which contains an information about a country in which the user of the mobile entity is currently located. Now there may exist inconsistencies between the determined city and the determined country. By way of example if the determined city is Madrid or Barcelona, the determined country necessarily needs to be Spain.

In general terms when a predefined functional relationship exists between different data sets, the processing rules take into account said predefined functional relationship and the virtualizing unit can detect inconsistencies for said one data set in accordance with the predefined functional relationships.

Furthermore, the processing rules can furthermore contain an information about a master data set for the predefined functional relationship, wherein the virtualizing unit corrects the detected inconsistency in the data set for which the predefined functional relationship exists using the information of the master data set for the predefined functional relationship. Applied to the above example of the city and the country, the information about the master data set contains the information which of the provided information, the city or the country, is necessarily correct. If it is known which of the two types of information is correct, the other type of information that is not correct may be corrected.

Furthermore, the rules provided by the data managing unit 200 will typically be based on specific values of the information pieces provided. By way of example the status of a specific mobile user may be stored in different data sets, but with the same logical syntax. In this case the consistency enforcement rules may verify that the data set has the same value in different repositories.

Other more complex cases may be handled as the case where the format of the data may be different. By way of example a number can be stored in an international format on one repository and in the national format only in other repositories. In this case the inconsistency detection rules will perform the needed translation before comparing the data sets of each repository.

The previous example can consider other pieces of information in the case that one of the repositories allows the storage of the number in a national and international format including an indicator of the selected format. In this example the inconsistency detection rules will process the number and number format indicator to perform the comparison.

The complexity may be even greater in case the semantic meaning of the data set is considered. By way of example in an IMS (IP Multimedia Subsystem) environment a specific application may be triggered by means of a specific IFC trigger. In this case the consumer access rules may verify if the user allowed to use a specific application has the proper IFC defined in the HSS (Home Subscriber System) to access the service.

As can be seen from the above examples, the rules and data relationships can have different levels of complexity requiring a logical, semantic or functional modeling of the information depending on the ambitions on the data quality objectives. In general terms the data managing unit 200 has the interface 212 to the different data repositories for detecting changes in the data sets that affect the processing rules, wherein the data managing unit comprises a processing unit (210) configured to adapt the processing rules based on the detected changes in the data sets.

Referring back to FIGS. 2 and 3 the common data access procedures such as create, read, update and delete, will be requested by the data consumer 50 to the data virtualizing unit 100 that should have the logic to identify in which data repository 310, 320 the data set needed to attend the request is stored and how these data should be accessed (e.g. which interface should be used, which keys, etc.). In some cases, when a specific piece of information is replicated in the system, the same data set can be accessed on other data repositories.

On top of this information generally available on all data virtualization systems the invention provides the processing rules for the data quality assurance that are enforced by the data virtualizing unit per piece of information for which a data access request is received. The enforcement by the data virtualizing unit contains the enforcement of the consumer access rules, the inconsistency detection rules, the consistency enforcement rules, and the final result rules discussed above. The rules used to maintain the data quality can have a varying degree of complexity. The rules may be based on data sets with a simple physical/logical information piece that is replicated, furthermore rules are known that include more complex semantic or functional relationships that may exist between information pieces or data sets.

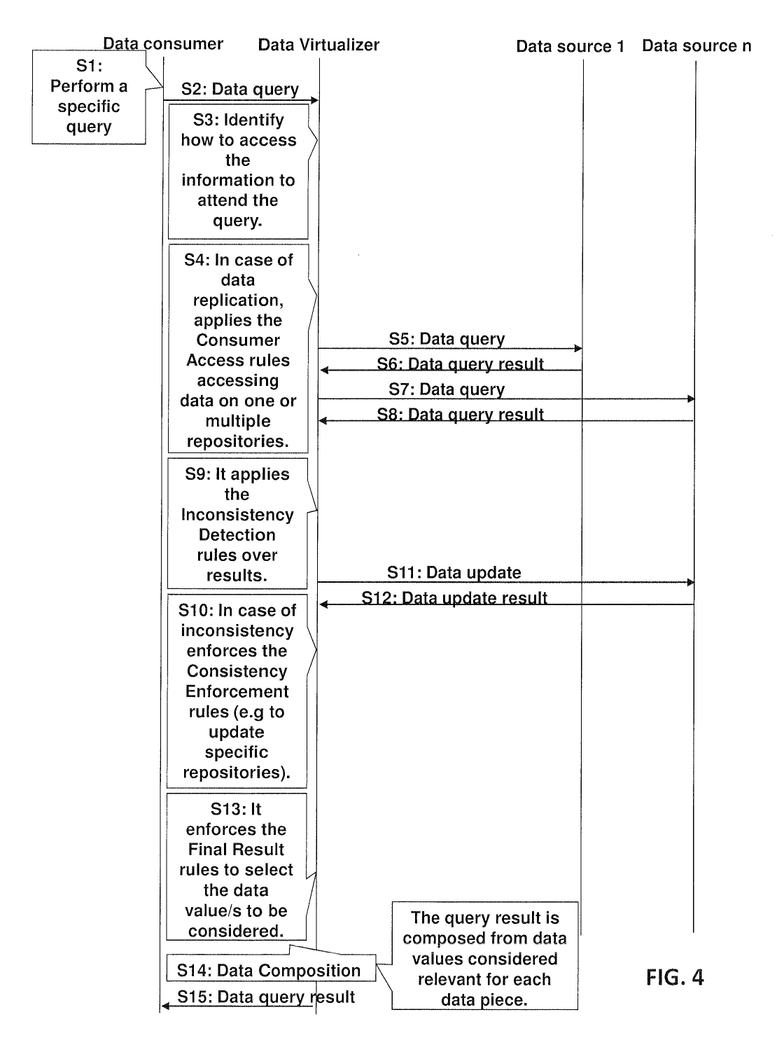

The decision flow is also shown in further detail in FIG. 4. In a step S1 a consumer performs a specific query and in step S2 this query is transmitted to the data virtualizing unit 100. In step S3 it is asked by the data virtualizing unit how to access the information to attend the query. If the data set is replicated in several data repositories in step S4, the consumer access rules are applied to determine which data set or which data sets in the one or more repositories are accessed. Thus, in step S5, as a result of the application of the consumer access rules, the data virtualizing unit accesses a first data source or data repository, the virtualizer receiving the result of the query in step S6. In the example shown the same data set was also stored in the data source n, so that in step S7 the query is also transmitted to this data repository, step S8 transmitting the data query result back to the data virtualizing unit. In step S9 it can then apply the inconsistency detection rules for the two query results received. If an inconsistency is detected, the consistency enforcement rules are applied by the data virtualizing unit. In the embodiment shown this means that the data virtualizing unit determines that the data set stored in data source n is the incorrect data set. As a consequence, in step S11 a data update is transmitted to data source n, the acknowledgement being transmitted back to the virtualizer in step S12. In step S13 the final result rules are enforced to select data set to be considered. In step S14 the data set returned to the data consumer is composed in a data composition step and in step S15 the result is transmitted back to the data consumer.

A further implementation of the invention is described in further detail below:

The data consumer may by way of example be an end user application that requests access to the reachability in location information of a telecommunication user. This will be referred to as the application. The source of information needed for the application is stored on different data repositories. In a telecommunication network the reachability and location information is accessible on different repositories. In this example we will consider the following repositories. The first repository may be the HSS (Home Subscriber Server) where the relation between multiple user identifiers is stored, a location status of the user, the location area where the user is allocated, the registration status on the IMS system. Furthermore, repository 1 provides information about supplementary services and restriction which were applicable to circuit-switched and packet-switched communications.

Another repository, the second repository, may be the PGM, the presence group data management where the present information of the user is stored. The third repository may be the MPC (Mobile Positioning Center) where location information of the user is stored such as the cell in which the user is located. The MPC can further contain geographical location information of the user derived by different technologies.

A fourth repository may be the domain name server DNS containing information about IP identifiers used by the user.

The fifth repository may be the AAA (Authentification Authorisation and Accounting) server. This repository contains information about the packet accesses of the user, such as information about the user IP connectivity and the IP profile information including possible traffic limitations to the user. A sixth repository may be the MTAS (Mobile Telephony Application Server) containing information about the user services applied to IMS, such as supplementary services and restrictions applicable to IMS communications.

This application uses a specific interface, e.g. SQL, towards the data virtualizing unit to access the relevant data from the system accessing the location information using potentially a specific data view with specific user identifiers. By way of example the following information may be relevant: the user identification, MSISDN (Mobile Subscriber ISDN), the user location, i.e. the status, network and geographical area, the user reachability, such as the status and identifiers where the user can be reached.

The data virtualizing unit now contains information regarding the data repositories in the system including the interfaces, capabilities and data models. The data virtualizing unit furthermore includes mechanisms to access these data repositories mentioned above.

The data virtualizing unit further holds information regarding the data view used for the application accessing the data and transformation mechanisms in models to derive this data view from repository data models. By way of example from MSISDN in the HSS the IMPUs (IP Multimedia Public Identity) can be obtained used in IMS systems. From the HSS the user status on wireless access can be obtained, the access network and the restrictions for mobile connectivity (e.g. incoming call bearing). From the HSS it is also possible to obtain the IMS user registration status on the IMS, the access network, the restrictions for mobile connectivity. From the MPC it is possible to obtain the geographical location information of the mobile user and from the AAA server the status of the user packet connections and associated IP addresses including related service profiles can be obtained. It may include mobile or fixed accesses. From DNS it is possible to obtain the identities used by the user on the IP network and the relation with IP addresses on AAA from the PGM repository the presence information per user IMPU can be obtained. From MTAS information about supplementary services and restrictions applicable to IMS can be obtained.

The data managing unit includes information indicating which of the replicated data in the system is considered the master. This information about the master is held by the data virtualizing unit.

The data virtualizing unit furthermore holds the data quality assurance rules to be applied and retrieved from the data managing unit.

When the applications perform the access, e.g. read, query, the data virtualizing unit enforces the consumer access rules. By way of example the rule to consider is access all data instances, e.g. due to the specific data consumer query that is necessary for the automatic correction of the inconsistent data. This means that all relevant information existing in a system shall be acceded. As a consequence, all data sets from the relevant repositories are retrieved by accessing the data sets in the repositories. When the different data sets have been retrieved, the data virtualizing unit enforces the inconsistency detection rules. By way of example in this case the rule to apply is “compare the value of each of the data sets that is necessary for identification of possible data inconsistencies. By way of example it can be identified that a IMPU defined in MTAS is not defined in HSS and that the country code of the MSC area HSS does not correspond to the country in MPC.

When inconsistencies are detected, the data virtualizing unit 100 enforces the consistency enforcement rules. One instance may be to overwrite all data sets to match the master instance. Considering the previously identified inconsistencies, the following actions may be taken as a consequence of this rule: the IMPU and MTAS that is not defined in HSS is removed and the location information on MPC is cleared.

At this point the information can be corrected and the query can be properly answered according to the final result rules enforced by the data virtualizing unit. In the example discussed the applicable rule is “return only the master data” as requested by the application. The answer in this case may be:
User identifier: MSISDN, IMPUs (except the ones removed from MTAS)
User location: Status on HSS, and network from HSS (geographical area on MPC has been cleared due to the inconsistency).
User reacheability (Status and identifiers): where the user can be reached:
MSISDN 34 91 512222222 via CS telephony with forwarding activate.
MSISDN 34 91 512222222 via SMS.
FQDN juan@ericsson.com via e-mail.
IMPU sip:juan@ericsson (other IMPU has been removed from MTAS)

Of course this is only an example and the variety or applicable rules may imply a completely different system behavior.

Summarizing, the described mechanism allows to ensure that a master data management process is performed even if the data virtualizing unit has no means of automatically detecting changes in the repositories. The data virtualizing unit is able to detect the data inconsistencies and can ensure data quality in real time every time a data access operation is performed.

1. A system handling a plurality of data sets stored in different repositories (310, 320), the system comprising:
a data managing unit (200) configured to provide processing rules for processing the data sets stored in the different repositories, the processing rules including access rules providing information which of the data repositories should be accessed in the case of a data access request for one of the data sets, the processing rules further including consistency enforcement rules providing correction actions when an inconsistency for said one data set stored in different data repositories is detected,
a virtualizing unit (100) configured to control data access requests for the data sets and configured to enforce the processing rules provided by the data managing unit (200), wherein, when the data virtualizing unit (100) detects the data access request for said one data set, the data virtualizing unit handles the data access request for said one data set, accesses at least two repositories (310, 320) where said one data set is stored based on the access rules, and corrects a detected inconsistency for said one data set based on the consistency enforcement rules.

2. The system according to claim 1, wherein the processing rules provided in the data managing unit (200) further include inconsistency detection rules providing information what to do with data sets retrieved from the at least two repositories for a data access request for said one data set, the virtualizing unit (100) being configured to compare the data sets contained in the accessed repositories relating to the detected data access request and to detect the inconsistency in the compared data sets based on the inconsistency detection rules.

3. The system according to claim 1 or 2, wherein the processing rules provided in the data managing unit further include final result rules providing information about a final result to be returned for said one data set in response to the data access request for said one data set, the virtualising unit (100) being configured to generate the final result for said one data set in response to the data set access request for said one data set based on the final result rules.

4. The system according to any of the preceding claims, wherein the data managing unit (200) contains, for each of the data sets, information which of the data sets stored in the different repositories is a master data set considered as the data set containing the correct information.

5. The system according to any of the preceding claims, wherein the virtualizing unit (100) is configured to determine in which data repositories said one data set for which the data access request is received is stored.

6. The system according to any of the claims 2 to 5, wherein, if the virtualizing unit (100) detects an inconsistency in said one data set for which the data access request is received, it determines which is the master data set and controls the data sets of the different repositories (310, 320) for which the data access request is received in such a way that the data sets of the different repositories (310, 320) for which the data access request is received match the master data set of said one data set.

7. The system according to any of claims 2 to 6, wherein a predefined functional relationship exists between different data sets, wherein the processing rules take into account said predefined functional relationship, wherein the virtualizing unit (100) detects inconsistencies for said one data set in accordance with said predefined functional relationship.

8. The system according to claim 7, wherein the processing rules further contain an information about a master data set for the predefined functional relationship, wherein the virtualizing unit (100) corrects the detected inconsistency in the data set for which the predefined functional relationship exists using the information of the master data set for the predefined functional relationship

9. A virtualizing unit (100) handling an access to data sets stored in different repositories, the virtualizing unit comprising:
a first interface (112) configured to receive processing rules for processing the data sets stored in the different repositories from a data managing unit (200), the processing rules including access rules providing information which of the data repositories should be accessed in the case of a data access request for one of the data sets, the processing rules further including consistency enforcement rules providing correction actions when an inconsistency for said one data set stored in different data repositories is detected,
a processing unit (110) configured to control data access requests for the data sets and configured to enforce the processing rules provided by the data managing unit (200), wherein, when the processing unit (110) detects a data access request for one data set, it handles the data access request for said one data set, accesses at least two repositories where said one data set is stored based on the access rules, and corrects the detected inconsistency for said one data set based on the consistency enforcement rules.

10. The virtualizing unit (100) according to claim 9, wherein the received processing rules further include inconsistency detection rules providing information what to do with data sets retrieved from the at least two repositories for a data access request for said one data set, the processing unit (110) being configured to compare the data sets contained in the accessed repositories relating to the detected data access request and to detect the inconsistency in the compared data sets based on the inconsistency detection rules.

11. The virtualizing unit (100) according to claim 9 or 10, wherein the received processing rules further include final result rules providing information about a final result to be returned for said one data set in response to the data access request for said one data set, the processing unit (110) being configured to generate the final result for said one data set in response to the data set access request for said one data set based on the final result rules.

12. The virtualizing unit (100) according to 10 or 11, wherein, if the processing unit (110) detects an inconsistency in the data set for which the data access request is received, it determines which is the master data set and controls the data sets of the different repositories (310, 320) for which the data access request is received in such a way that the data sets of the different repositories for which the data access request is received match the master data set of said one data set.

13. A data managing unit (200) configured to manage a plurality of data sets stored in different repositories, comprising:
a storage unit (220) storing processing rules for processing the data sets stored in the different repositories, the processing rules including access rules providing information which of the data repositories should be accessed in the case of a data access request for one of the data sets, the processing rules further including consistency enforcement rules providing correction actions when an inconsistency for said one data set stored in different data repositories is detected,
an interface (211) providing the processing rules to a virtualizing unit enforcing the received processing rules.

14. The data managing unit (200) according to claim 13, further comprising an interface (212) to the different data repositories (310, 320) for detecting changes in the data sets that affect the processing rules, wherein the data managing unit comprises a processing unit (210) configured to adapt the processing rules based on the detected changes in the data sets.

15. A method for handling a plurality of data sets stored in different repositories, the method comprising the steps of:
receiving a data access request for one of the data sets,
accessing at least two repositories (310, 320) where the data set for which the data access request is received is stored based on access rules providing information which of the data repositories should be accessed in the case of a data access request for one of the data sets,
detecting inconsistencies for said one data set stored in the at least two repositories based on inconsistency detection rules providing information what to do with data sets retrieved from the at least two repositories for a data access request for said one data set,
correcting an inconsistency for said one data set based on consistency enforcement rules providing correction actions when an inconsistency for said one data set stored in different repositories is detected.

16. The method according to claim 15, further comprising the step of returning a final result for said one data set in response to the data set access request for said one data set based on final result rules, the final result rules providing information about a final result to be returned for said one data set in response to the data access request for said one data set.
